(19) United States
(12) Patent Application Publication
(10) Pub. No.: US 2013/0058029 A1
(43) Pub. Date: Mar. 7, 2013

(54) MODULAR DATA CENTER

(71) Applicants: Hideyoshi Ootani, Chiba-ken (JP); Kazuhide Sato, Chiba-ken (JP); Makoto Honda, Tokyo (JP); Koichi Hashimoto, Tokyo (JP); Tomoyuki Kinoshita, Kanagawa-ken (JP); Masaaki Yamamoto, Kanagawa-ken (JP); Kobun Takahashi, Tokyo (JP); Hiroshi Morimoto, Chiba-ken (JP)

(72) Inventors: Hideyoshi Ootani, Chiba-ken (JP); Kazuhide Sato, Chiba-ken (JP); Makoto Honda, Tokyo (JP); Koichi Hashimoto, Tokyo (JP); Tomoyuki Kinoshita, Kanagawa-ken (JP); Masaaki Yamamoto, Kanagawa-ken (JP); Kobun Takahashi, Tokyo (JP); Hiroshi Morimoto, Chiba-ken (JP)

(21) Appl. No.: 13/557,635

(22) Filed: Jul. 25, 2012

(30) Foreign Application Priority Data
Jul. 28, 2011 (JP) 2011-166089

(51) Int. Cl. G06F 1/20

(52) U.S. Cl. 361/679.31

(57) ABSTRACT

A data center is disclosed that includes a container; a server; a rack installed within the container and storing the server; and a curtain fixed to at least one point of the rack or the container and separating an internal space of the container between a cold side and a hot side; wherein the rack is configured to enable the circulation of air from the cold side to the hot side. The curtain is fixed by a removable clamping mechanism. The data center further includes a modular refrigeration unit configured to attach to the container and direct cold air into the cold area. At least one prop is positioned below a bottom of the housing and connected to a container bottom, the prop is configured to absorb vibration of the container or housing.

This application is based upon and claims the benefit of priority from the prior Japanese Patent Application No. 2011-166089, filed on Sep. 28, 2011, the entire contents of which are incorporated herein by reference.

### FIELD

Following embodiments relate generally to a computing data center. More specifically, a modular data center with modular components suitable for use with rack or shelf mount servers or computing systems, for example, is disclosed.

### BACKGROUND

A modular data center is able to correspond flexibly to a requirement of expanding servers. Compared to construction of an existing data center inside an existing building, construction of the modular data center is able to be completed in a short time.

The modular data center is able to take in open air with ease and achieving energy savings is expected by using the open air for cooling inside the data center.

Research and development of eco-friendly technology including the module and the modular data center have been done.

Structures of a module or a modular data center are required to withstand a big earthquake. When the modular or modular data center is put in the ship on the sea, the structures are required to withstand the swaying of the ship at sea or anchor.

### BRIEF DESCRIPTION OF THE DRAWINGS

FIG. 1 is a perspective diagram illustrating the configuration of a module and an air conditioning unit according to a first embodiment;

FIG. 2 is a dismantlement perspective diagram illustrating the configuration of a module according to a first embodiment;

FIG. 3 is a dismantlement perspective diagram illustrating the configuration of a module according to a first embodiment;

FIG. 4 is a connection diagram illustrating the connection of a module and a rack according to a first embodiment;

FIG. 5 is a magnified diagram illustrating the configuration of a curtain according to a first embodiment;

FIG. 6 is a sectioned diagram illustrating the configuration of X-Z cross section of a module according to a first embodiment;

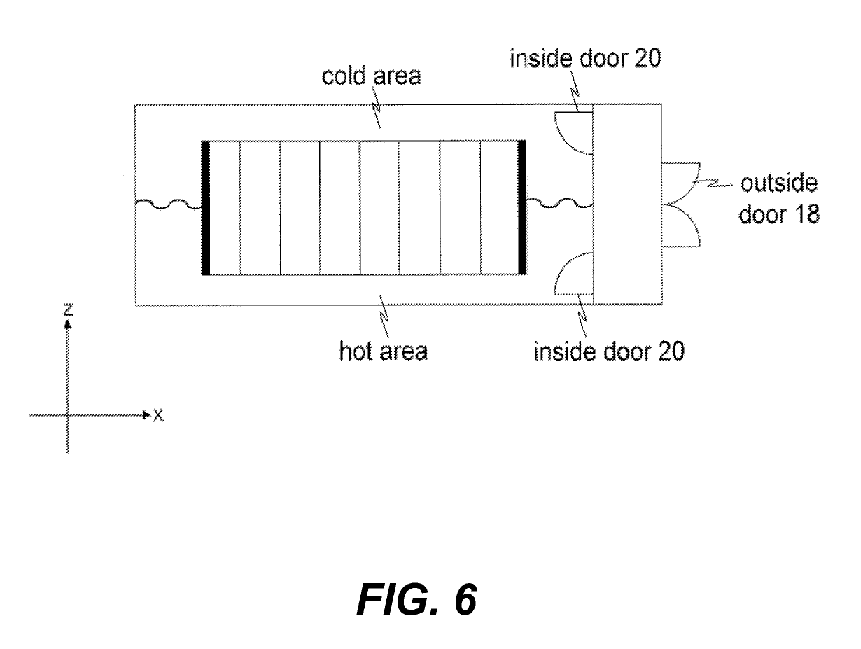

FIG. 7 is a sectioned diagram illustrating the configuration of X-Y cross section of a module according to a first embodiment; and

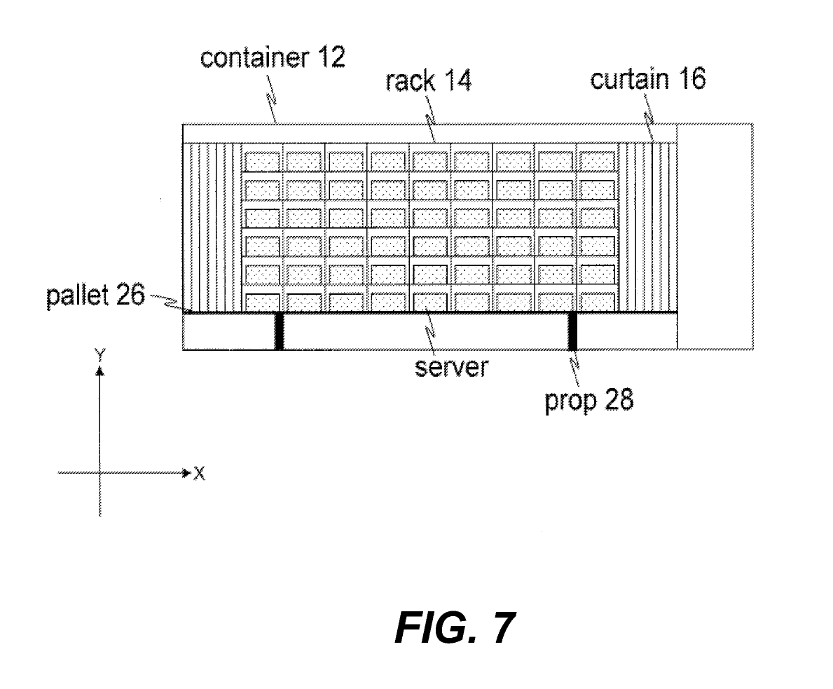

FIG. 8 is a magnified diagram illustrating the configuration of a curtain according to a first embodiment.

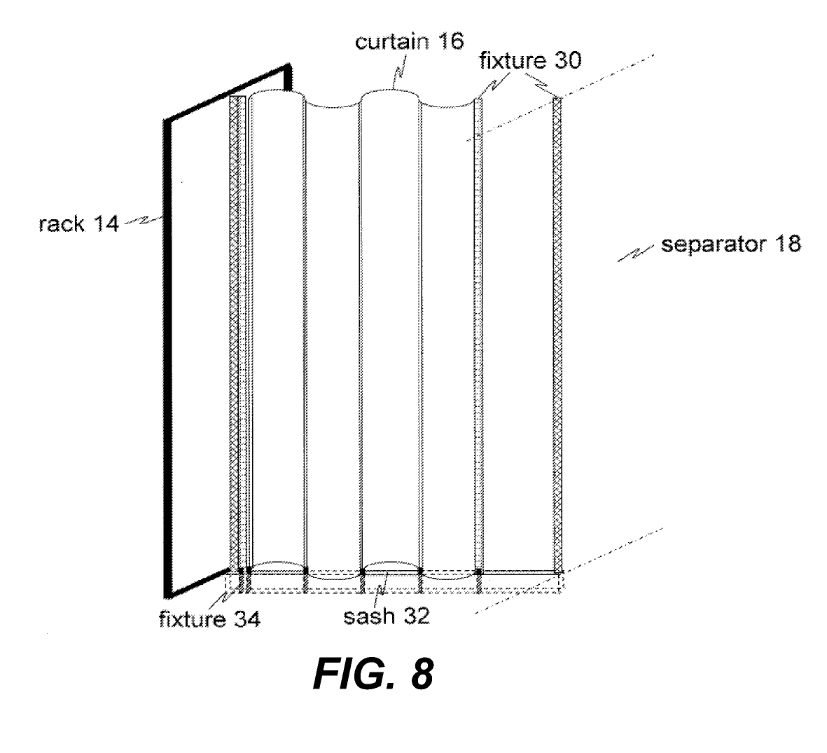

### DETAILED DESCRIPTION

A modular data center according to one embodiment includes a housing; a cooled medium mounted on a first position within the housing; and a curtain fixed at least one point of the cooled medium or the housing, stretching in response to movement of the cooled medium from the first position, and dividing the housing.

### First Embodiment

A first embodiment is described by referring to the drawings.

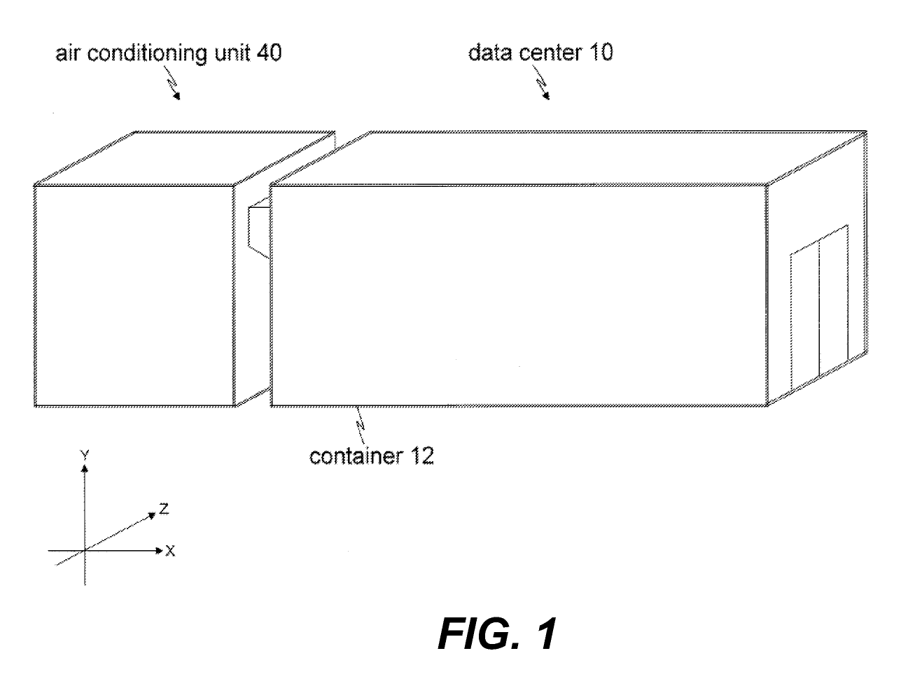

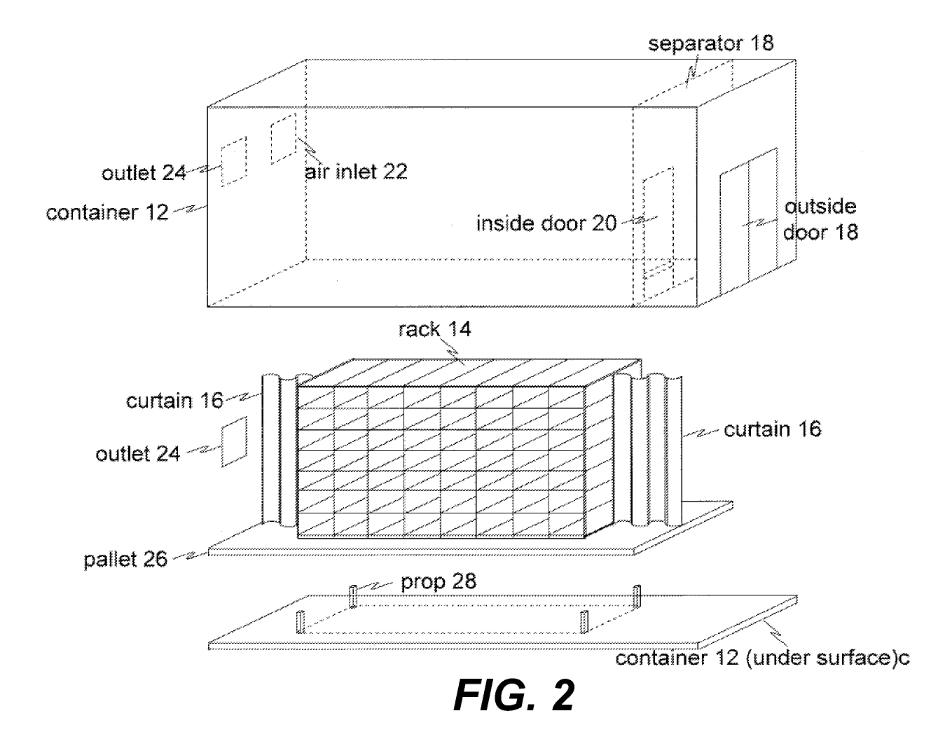

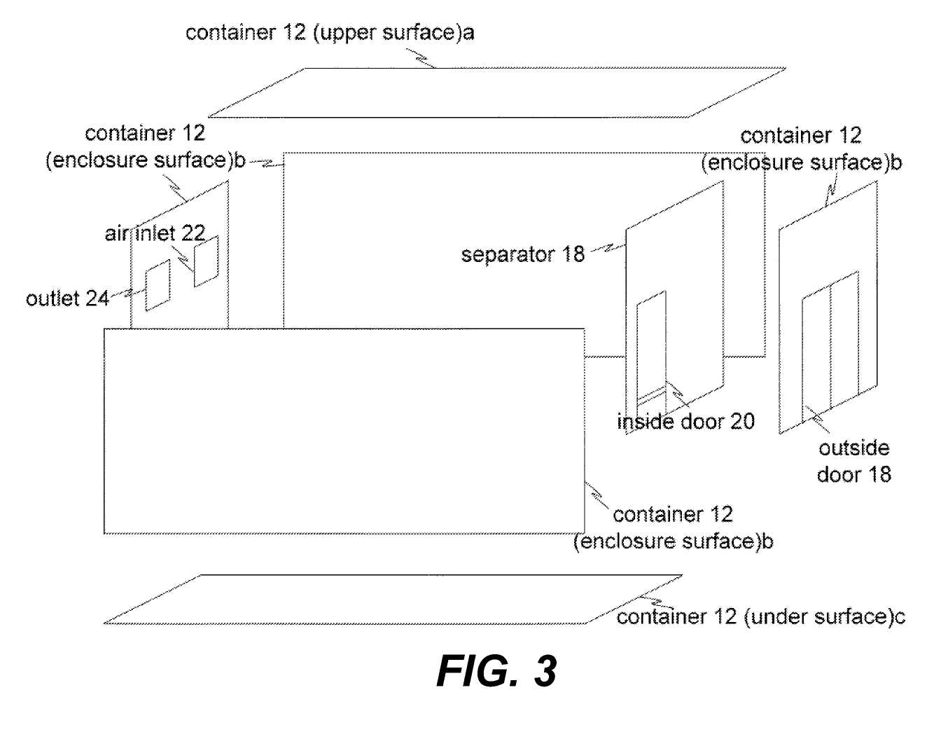

FIG. 1 is a perspective diagram illustrating the configuration of a module and an air conditioning unit according to a first embodiment. FIG. 2 is a dismantlement perspective diagram illustrating the configuration of a module according to a first embodiment. FIG. 3 is a dismantlement perspective diagram illustrating the configuration of a module according to a first embodiment.

The modular data center 10, as shown in FIG. 1 and FIG. 2, includes a housing 12 shaped rectangular or hexahedral structure and a rack or plural racks stored in the housing 12. FIG. 2 shows eight racks 14. According to the first embodiment, the modular data center 10 and the air conditioning unit 40 are connected by a two-way air traffic constituent such as a pipe or a metal can through the air inlet 22 and the outlet 24. The module may be installed on land, on sea, on a ship on the sea, on a plane in the sky, in the sea or in space. The module may connect to a container which includes a generator providing electrical power to servers or air conditioning unit such as UPS stands for uninterruptible power supply or a cooling tower. The modular data center 10 may be called the container data center, the module data center, or the cell modular datacenter.

The air conditioning unit 40 is illustrated as an air-cooling system, but the air conditioning unit 40 may use a liquid cooling system that circulates a heating medium or a solution such as water to a cooled medium when the modular data center 10 is installed near a lake, river or ocean. The modular data center 10 may be installed inside structures such as a building or outside of structures. When a data center accommodates plural containers or modules, a part of the plural containers or modules may be installed inside of buildings and the others installed outside of buildings. The modular data center 10 may connect with a cooling tower, a generator such as a gas electric power generator, a thermal electric power generator, or a nuclear electric power generator, an emergency power supply unit, a computer, a management server, or a container or module which accommodates those equipment illustrated above. The modular data center 10 may connect with an external wired or wireless communication network. The modular data center may have solar panels or wind power generator thereon. The modular data center 10, a part of or every components or elements are tested or assembled at a factory or installed location. The modular data center 10 or the air conditioning unit 40 may be managed by a remote supervision through an external circuit such as an internet.

The container 12 is a box-like housing that is formed of steel, aluminum, or FRP, which is fiber-reinforced plastics. The container 12 may have a hook to be picked itself up, or a breathable wall to maintain an air exchange. Generally, the container lengths are 10′, 12′, 20′, 24′, 44′, 45′, 46′, 53′, 56′, or less than 10′. Generally, the container width and height are 8′, 8′6″, 9′, or 9′6″. Various ISO standard containers are able to be used as the container 12.

A pre-designed container not exceeding the highway's weight limit such as 20 tons is suitable for the container 12, but other container may be used. Containers are used to explain in this embodiment, but any other module or housing may be used. Containers or modules having any other size in length, in width, or in height may be used. Containers constructed at the place such as a factory that is a different location from an installation location and are able to be transported to the installation location by moving medium such as truck, railway, or containership are suitable for the container 12. Modules are able to be constructed with ease such as a temporary dwelling. The structure of the container 12 may have polyhedral structure, columnar structure, or spherical structure in addition to the above-mentioned hexahedral structure.

The rack 14 is a grid-shaped housing that is formed of steel, aluminum, or FRP, which is fiber-reinforced plastics. The rack 14 is able to accommodate a thin server shaped blade. The rack 14 has a plurality of housing units separated by walls and the plurality of housing units accommodate the servers. The servers are arranged in same direction. The arrangement of servers makes a cold area and hot area. At the cold area, air inlet 22 intakes, air cooling the servers, and at the hot area, outlet 24 emits warm air to the outside of the container 12. For instance, EIA standard's racks which have 19 inches in width and 1.75 inch in height (any length in depth) are able to be used as the container 12. In addition to the container, JIS standard's racks are able to be used. Substituted for the rack having eight server racks, the rack having one or more server racks is able to be used. Substituted for the rack having a server, the rack having an air conditioner is able to be used. It is also possible to place the rack having a server and the rack having an air conditioner alternately. When there are gaps between the rack 14 and container 12 (upper surface)a, or between the rack 14 and the container 12 (under surface)c, separator for separating the internal space of the container into a hot area and a cold area may be used at the top or bottom of the rack 14. The pallet 20 and the rack 14 are able to slide or move along the surface with continuous contact on that surface and with each other. Their relative position is able to be shifted by a shaking of an earthquake or etc.

In place of servers which are accommodated in the rack 14, generators or any other products are able to be put into the place. Curtain 16 is a curtain that separates in the container 12. For instance, the curtain 16 separates an internal space of the container 12 into a hot area and a cold area. For materials, flexible material impervious to air such as polyvinyl chloride or metal is preferable. Substituted for these materials, coarse textured clothes or any other materials can be used. The curtain 16 is fixed on the rack 14 or inner peripheral surface of the container 12. A member subject such as a clip is used to fix on the curtain to the container 12. A magnet can be used to fix the curtain 16 having magnets put in four points to the container 12, rack 14 or Separator 18. People are able to walk around inside the container 12 having this detachable structure. In place of the curtain, a member subject having a dividing or separating function and a stretch function is able to be used.

When the container 12, the rack 14 or the separator 18 fix on the curtain 16 at one point, having hardness above a certain level is needed for the curtain 16 to separate the area inside the container 12. As the curtain 16, a fold type curtain such as an accordion curtain is preferable. When the container 12, the rack 14 or the separator 18 fix on the curtain 16 at many points such as a line, flexible materials such as polyvinyl chloride or cloth are able to be used.

What the curtain 16 is not fixed on the upper side of the pallet 26 or the container 12 is preferable. If the earthquake hits the modular data center and the pallet 26 moves in the direction of lateral vibration, the rack 14 is able to slide while holding both ends of the curtain 16. In the case that the curtain 16 having elastic force above a certain level and/or hardness above a certain level is able to absorb the vibration energy generated by the transportation such as ship, train, track, car or earthquake because of the flexibility and/or rigidity.

The pallet 26 supports the rack 14 and the pallet 26 is connected with the container 12 through the prop 28. The pallet 26 is able to be used as an aisle that people can move on.

The pallet 26 is shaking according to the vibration of the prop 28 when the module is swayed by an earthquake. After the end of the vibration of the prop 28, the pallet 26 gets back in place.

The prop 28 is a positioning member to position the place of the rack 14.

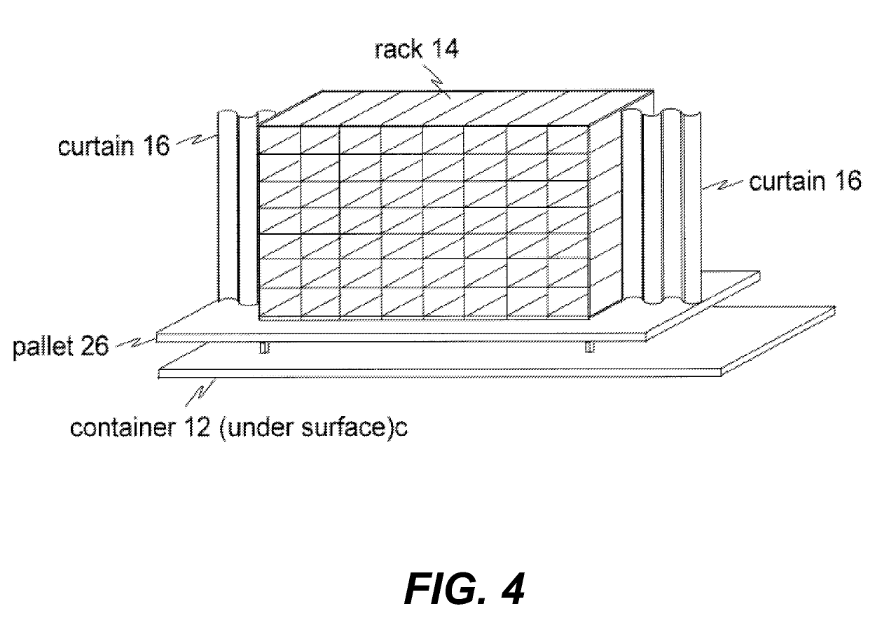

The following describes the structure of the container 12 comprising the modular data center 10. As shown in FIG. 1 though FIG. 4, the container 12 is comprised by an upper surface, an enclosure surface that has four sides, and an under surface. At least one surface of the container 12 (upper surface)a, the container 12 (enclosure surface)b, and the container 12 (under surface)c has an air exhausted opening that exhausts air from the hot area that is mentioned later. At least one surface of the container 12 (upper surface)a, the container 12 (enclosure surface)b, and the container 12 (under surface)c has an air supply opening that supplies air from the cold area. The air exhausted opening 24 exhausts the air in the hot area. The air supply opening 22 supplies the air that is colder than the air in the hot area from the air conditioner 40 or the outside of the container 12. These openings make the container possible to circulate the airs and achieve an effective cooling system

The container 12 in this embodiment has the outside door 18 that make it possible for people to go inside and out from the outside of the container 12. The inside door 20 separates the inside of the container 12. These two doors make the container 12 having the rack 14 possible to keep the temperature, humidity, and/or air pressure therein.

The rack 14 in this embodiment is designed smaller than the internal floor area of the container 12. The space between the container 12 (enclosure surface)b and rack 14 is able to be used as an aisle. In this embodiment, people are able to pass on the pallet 26. When the container 12 doesn't have the pallet 26, people are able to pass on the container 12 (under surface)c.

The curtain 16 in this embodiment achieves the efficiency of air conditioning by separating the hot and cold area. When the container 12 doesn't have the curtain 16, the heat transfers actively between the hot area and the cold area and the hot air does not evacuate efficiently and the cold air does not supply to the rack 14.

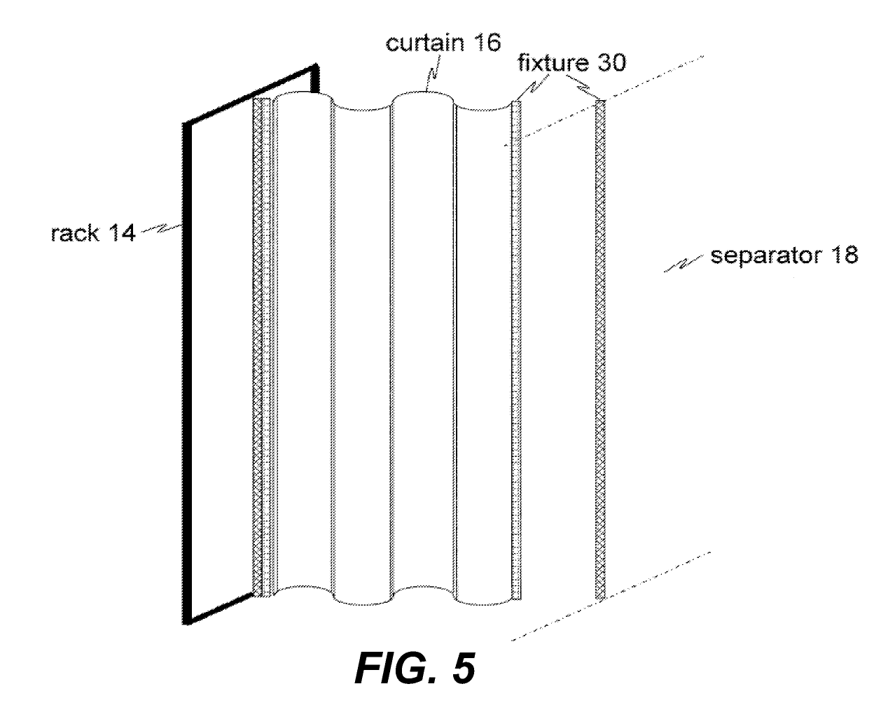

As shown in FIG. 5, the fixture 30 fixes the curtain 16. The fixture 30 is removable. The fixture 30 is comprised of magnets or removable and zipping material. This mechanism makes the people pass inside the container 12 when the fixture 30 is unfastened.

As described above, the container or module with quake-absorbing structure separates the hot area and cold area inside the container or the module. By adopting the movable material (open and close mechanism) such as the curtain 16, people can pass inside the container or the module. When the data center is shaken and the difference of shake occurred between the container 12 and the internal structure such as the rack 14, the curtain 16 is able to keep the separate function regardless of the difference by the elasticity.

### Second Embodiment

The difference of the module and modular data center described in the second embodiment and in the first embodiment is the quake-absorbing structure. In this embodiment, the module and modular data center put in the building are supposed.

The prop 28 is an elastic organ to absorb a vibration of the earthquake. As the elastic organ, a spring or rubber is used. The prop 28 and the pallet 26 are able to be formed together. The prop 28 and the container 12 are able to be formed together.

The position of the rack 14 having the server as a cooled medium inside the container 12 is located by the prop 28 and the pallet 26. This sort of positioning member such as a hanging rod or hanging chain is able to locate the rack 14 from top or side part thereof. Pluralities of poisoning members are able to locate the rack 14 from top, side and/or bottom part. When the container 12 is inside the ship, the container 12, the rack 14, and the pallet 26 are able to shake respectively by the elasticity of the prop 28. The difference of each shaking realizes base isolated system and prevents damage to the server.

### Third Embodiment

The difference of the module and modular data center described in the third embodiment and in the first and second embodiment is the curtain 16.

In this embodiment, the curtain 16 may not be able to maintain the shape by the pressure difference between hot and cold area and/or circulation of the air. To cope with this, inserting the fixture 34 that attached to the curtain 16 to the sash 32 that arranged on the pallet 26 and/or the inner surface of the container 12 is adopted. The curtain 16 is fixed to the vertical direction toward the direction of opening the curtain 16, which the direction is perpendicular to the direction of air pressure extended on the curtain 16.

Other retaining mechanism such as a magnet is able to be used as the sash 32 and/or the fixture 34.

As a result, even if the curtain 16 is made of a soft material, it is possible to maintain the shape and the function of separation of the area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A modular data center, comprising:
a housing comprising an interior defined by housing walls;
an electronic device disposed within the interior; and
a flexible curtain located between an end of the electronic device and the housing wall, the curtain configured to at least partially divide the interior into a cold area and a hot area, wherein the electronic device is configured to enable the passage of air from the cold area to the hot area.

2. The modular data center of claim 1 wherein the electronic device comprises one or more of a server and a server rack and wherein the housing comprises a container.

3. The modular data center of claim 1 further comprising a refrigeration unit configured to direct cold air into the cold area.

4. The modular data center of claim 3 wherein the refrigeration unit is configured to receive air from the hot area.

5. The modular data center of claim 4 wherein the refrigeration unit generates the cold air directed to the cold area by cooling the air received from the hot area.

6. The modular data center of claim 4 wherein the refrigeration unit is modular and the housing comprises an inlet for receiving cold air from the refrigeration unit and an outlet for conveying hot air out of the hot area.

7. The modular data center of claim 1 further comprising at least one prop positioned below a bottom of the housing and connected to a container bottom, said prop configured to absorb vibration of the container or housing.

8. A data center, comprising:
a container;
a server;
a rack installed within the container and storing the server; and
a curtain fixed to at least one point of the rack or the container and separating an internal space of the container between a cold side and a hot side; wherein the rack is configured to enable the circulation of air from the cold side to the hot side.

9. The data center of claim 8, wherein the curtain is fixed by a removable clamping mechanism.

10. The data center of claim 8 further comprising a modular refrigeration unit configured to attach to the container and direct cold air into the cold area.

11. The data center of claim 10 wherein the refrigeration unit is configured to receive air from the hot area.

12. The data center of claim 11 wherein the refrigeration unit generates the cold air directed to the cold area by cooling the air received from the hot area.

13. The modular data center of claim 8 further comprising at least one prop positioned between a pallet located below the rack and a bottom of the container, said prop configured to absorb vibration of the container, wherein the curtain comprises a flexible material.

14. A method for housing a server comprising:
directing cold air from a cold side of a container to a hot side of the container through a server stored in a rack, the container divided into a cold side and a hot side by the server and server rack and a curtain that is attached to a wall of the container and at least one side of the server or rack, such that cold air is directed over the server and cools the server as the cold air is directed to the hot side of the container.

15. The method of claim 14 wherein the cold air is cooled by a refrigeration unit configured to direct cold air into the cold area.

16. The method of claim 15 further comprising directing air from the hot side to the refrigeration unit and wherein the refrigeration unit generates the cold air directed to the cold area by cooling the air received from the hot side.

17. The method of claim 15 wherein the refrigeration unit is modular.

18. The method of claim 14 further comprising absorbing vibration of the container using at least one prop positioned below a pallet within the container that the server and rack rest upon.

19. The method of claim 14 wherein the curtain comprises a flexible material.

20. The method of claim 14 wherein the curtain is fixed by a removable clamping mechanism.
